(19) United States
(12) Patent Application Publication
(10) Pub. No.: US 2012/0180701 A1
(43) Pub. Date: Jul. 19, 2012

(54) INERT FILLER FOR EXPLOSIVE DEVICE AND METHOD FOR MAKING AND LOADING SAME

(76) Inventor: Tim R. Benson, Burlington, IA (US)

(21) Appl. No.: 11/930,994

(22) Filed: Oct. 31, 2007

(51) Int. Cl. C04B 14/00

(52) U.S. Cl. 106/471

(57) ABSTRACT

An inert filler for a munition is disclosed. The inert filler includes a mixture of gypsum, fatty acid and inorganic sodium. A coloring agent may also be included in the mixture. A method of forming the inert filler and a method of loading the inert filler in a munition are also disclosed.

### FIELD OF INVENTION

This invention relates to compounds for use with an explosive device. More specifically, the invention relates to an inert filler for use with munitions.

### BACKGROUND

Inert filler is used in explosive devices, such as projectiles, mortars and the like. Typically such material is used in place of explosive compounds, such as TNT, Composition-B and black powder, to produce a non-explosive munition.

Current material used as inert filler includes a mixture of multiple compounds, and specifically a mixture of glyceride, dead burned gypsum, iron oxide, and rosin. This inert filler (termed Inert Filler E) includes 35 weight percent glyceride, 40 weight percent dead burned gypsum, 20 weight percent iron oxide, and 5 weight percent rosin.

Rosin has several undesirable characteristics, and is more expensive than other inert components. Due to the nature and traits of rosin, which is a solid form of resin, loading an explosive device using such material requires that the rosin be prepared at a first location (or on a first production line), and then shipped to a second production location or line. This results in extra handling of the material, adding cost and time to a production process. Rosin is typically sold in a large metal drum, such as a 55 gallon metal drum, that must be cut open lengthwise to extract or remove the rosin. Rosin in such a container is typically provided as one solid piece. The rosin must be broken down into smaller diameter pieces, such as 8 inch diameter pieces. The smaller pieces of rosin permit the rosin to be placed into a grinder. Breaking apart the rosin is typically a task performed with the assistance of a jack hammer once the rosin is removed from the drum. Thus, to remove the rosin, a portable jack hammer and a half tank cart, as well as a hoist and fork lift are often used. A grinder is used to grind the rosin to the appropriate size for forming the inert fill. Unfortunately, a grinder requires additional space, and a hood is required for ventilation. Additionally, rosin can only be ground for a day's worth of production. Rosin is also prone to form clumps and/or fuses back together if any heat exists at all which is greater than 80 degrees Fahrenheit. This is a problematic characteristic, particularly when drilling into a projectile which causes heat generation. Rosin also has a tendency to stick to everything and is generally difficult to clean from the equipment, used to handle same or used to produce the inert filler and to load the explosive devices.

Drilling is also difficult using rosin. In addition to the heating issues, generally, a five inch shank on a funnel is required. This reduces drilling to less than ½ inch, however this only allows around 100 projectiles maximum per a typical ten hour shift to be drilled. In contrast, compositions, such as Composition-B and TNT can be drilled at a rate of about 1000 per shift, using the same number of operators. In addition, a five inch drill shank is much more difficult to remove from the drilling equipment than a standard two inch shank because of poor ergonomic characteristics.

In addition to rosin, as discussed above, current inert fill includes iron oxide. Iron oxide is a very light weight powder. Specifically, the powder is composed of small size particles. As a result, the particles travel or disperse easily and excessively, even with ventilation. The particles are also difficult to clean from equipment. Iron oxide is commonly known as “rust”. As is known, rust attaches easily to metal. In addition, iron oxide heats up when drilled, and when added to rosin, the result is that the rosin gums up or clumps. Moreover, iron oxide, like rosin, is expensive as compared to other filler components.

Thus, the current formulation and components used to create inert filler result in increased time and expense to create the munitions, and have several undesirable characteristics.

Accordingly, what is needed in the art is an inert filler that is lower cost, requires less labor to produce and/or load into munitions, does not stick to the equipment during production, is easy to clean from the equipment, easy to machine and is more environmentally friendly than rosin and/or iron oxide.

### SUMMARY OF THE INVENTION

An inert filler, a method of forming same, and a method of loading a munition including the inert filler are provided.

More specifically, an inert filler for a munition is disclosed. The inert filler includes a mixture of gypsum, fatty acid and inorganic sodium. A coloring agent may also be included in the mixture. This mixture has several desirable properties which provide advantages over currently available inner fillers. A method of forming the inert filler is also provided including heating a fatty acid to form a liquid base, and adding proportional quantities of calcium sulfate and inorganic sodium to the mixture to form a wet mixture of inert filler. A method of loading the inert filler in a munition is also provided.

### BRIEF DESCRIPTION OF THE DRAWINGS

FIG. 1 is a side elevational view of an exemplary cast used to test the thermal expansion of the inert filler.

FIG. 2 is a cross-sectional view of the cast of FIG. 1.

### DETAILED DESCRIPTION OF PREFERRED EMBODIMENTS

As can be understood by the disclosure herein, the invention is embodied in an inert filler. The inert filler of the preferred embodiment may be loaded into a projectile, mortar, or other munitions, and is preferably loaded in place of an explosive composition. More specifically, an inert filler is provided which has a chemical composition suitable for use in association with, or compatibility with, explosive devices or munitions and various chemicals and compositions associated therewith.

The inert filler of the preferred embodiment is composed of the following characteristics. The filler has a density ranging from at least 1.30 to 1.90 grams/cc and more preferably ranging from at least 1.55 to 1.85 grams/cc and even more preferably, approximately 1.63 grams/cc. Thus, the inert filler may be used in an explosive device to a density of approximately 1.63 grams/cc so as to be able to match the density requirements of the common explosives it replaces (i.e., 1.55-1.85 grams/cc). The filler is also environmentally friendly and is relatively stable. In other words, each ingredient or component of the filler will not react with the other components of the inert filler, nor will it react with the explosive chemical added thereto. The preferred inert filler composition is compatible with: TNT (trinitro-toluene), Composition-B (including mixtures of RDX and TNT), black powder (including mixtures of a nitrate, charcoal, and sulfur), silicone, and/or red oxide primer paint, one or more of which may be used in the interior of a projectile or explosive, and/or olive green paint, as is often used in the top coat of projectiles, and/or aluminum as is often used in liners and funnels used to prepare the relative components and projectiles. In addition, the preferred inert filler is affordable, and can be able to be drilled easily without undesirable effects. Finally, the inert filler of a preferred embodiment has limited expansion/contraction under normal conditions, does not produce abnormal thermally induced stresses at temperature extremes, and has a coefficient of the thermal expansion which closely matches that of the explosive used. More preferably, the inert filler has an expansion/contraction which is similar to or less than that of TNT and/or Composition-B. Preferably, the inert filler comprises a specific gravity (H₂O=1) of 1.55 to 1.75, a vapor pressure of less than 1 mmHg, and a melting point ranging from approximately 185° F. to 195° F. The inert filler preferably comprises a solubility in water ranging from 5 weight percent to 45 weight percent, and more preferably, at least approximately 33 weight percent.

In view of the foregoing characteristics, the inert filler of one embodiment is formed by a mixture of a fatty acid and an inorganic sodium compound. Preferably, the inert filler does not contain iron oxide and/or rosin although trace amounts thereof would not depart from the scope of the invention. More preferably, the inert filler is a mixture, and preferably an intimate mixture of a fatty acid, a gypsum, and an inorganic sodium compound. This mixture provides significant advantages over the currently available inert fillers which include iron oxide and rosin. Most obvious, the issues associated with iron oxide and with rosin are eliminated.

More specifically, the inert filler is formed of a mixture of glyceride ranging from approximately 23 to 43 weight percent, dead burned gypsum ranging from approximately 23 to 43 weight percent, and inorganic sodium compound ranging from approximately 23 to 43 weight percent. Even more specifically, the inert filler comprises approximately 33 weight percent glyceride, approximately 33 weight percent dead burned gypsum, and approximately 33 weight percent sodium chloride, or more preferably 33.3 weight percent glyceride, 33.3 weight percent dead burned gypsum, and 33.3 weight percent sodium chloride. In view of the foregoing, the inert filler mixture may be composed of 12-hydroxy stearic acid, anhydrite calcium sulfate, sodium chloride, and in some instances water-propylene glycol based coloring. The constituents of the inert filler are mixed accordingly so as to form a composition including the approximately 33 weight percent 12-hydroxy stearic acid, approximately 33 weight percent anhydrite calcium sulfate, approximately 33 weight percent sodium chloride and approximately less than 1 weight percent water-propylene glycol based coloring. More preferably, approximately 33.3 weight percent of each of 12-hydroxy stearic acid, anhydrite calcium sulfate, and sodium chloride are mixed to form the inert filler, arriving at an approximate density of 1.63 grams/cc. Each of the foregoing constituents may be adjusted within a range of plus or minus 10 weight percent to arrive at the density, without departing from the overall scope of the present invention. The coloring, and more specifically the water-propylene glycol based coloring may be added in an amount necessary to arrive at the desired color.

Fatty acids contemplated by the present invention include glycerides or esters formed from glycerol and fatty acids and similar compounds. More preferably, the fatty acid may be 12-Hydroxy-Stearic Acid. Fatty Acids, such as 12-Hydroxy Stearic Acid (Hydroxyoctadecanoic acid or (CH₃(CH₂)₅(CHOH)(CH₂)₁₀COOH)) are generally commercially available, and may be obtained from Acme Hardesty Co., Inc. (Jenkintown, Pa.).

Gypsum fillers contemplated by the present invention include dead burned gypsum or calcinated anhydrous gypsum, anhydrite calcium sulfate. Gypsum fillers are generally commercially available and may be obtained from United States Gypsum Company (Chicago, Ill.) under the names, Terra Alba—F & P Grade, Terra Alba—No. 1, SNOW WHITE Filler, SNOW WHITE Filler—F & P Grade, CA-5 Filler, RD-80 S, CALOPONE Filler, CAS-20-2, CAS-20-4, KEENES Filler, BRITONE Filler.

In a preferred embodiment, an inorganic sodium may be provided in the mixture. The inorganic sodium compound is preferably sodium chloride. Alternatively, calcium chloride, or magnesium chloride may be used in place of sodium chloride. Mixtures of one or more of the foregoing are also contemplated. The inorganic chloride preferably provides a density mix of approximately 1.63 grams/cc. It is contemplated that the micron size of the inorganic sodium added to the mixture may be adjusted to increase viscosity and aid in keeping the mixture consistent throughout. Inorganic sodium compounds, such as sodium chloride (NaCl, salt, rock salt, saline, table salt), are generally commercially available and may be obtained from J.T. Baker Inc. (Phillipsburg, N.J.) and/or Cargill Salt Division, Leslie Salt Co. (Newark, Calif.).

In a further embodiment, a glycol may be added to the inert filler mixture. For instance, a color may be added to the inert filler, such as a food coloring which, as a non-limiting example, may be ethyl glycol and/or water based, to color the inert filler in a manner which makes it easily identifiable from one or more other materials. For example, a pink coloring may be added to the inert filler mixture.

Anti-corrosive agents compatible with the inert filler materials may also be added to the mixture forming the inert filler.

The process of producing an inert filler using the foregoing for use in a munition is described according to a preferred embodiment. The constituents are heated to a temperature, ranging from 200° F. to 220° F. Preferably, the components of the mixture are heated in a water or steam jacketed kettle. While heat is applied, the components of the mixture are placed in the kettle and are constantly agitated. The agitator blades may be stopped and cleaned/scraped as required.

To form the inert filler of a preferred embodiment, dry inert material is received, and prepared for melting. Inert filler material is weighed on a scale, and preferably a calibrated scale, to arrive at the selected amount, and then transferred to loading pots for loading into the kettle. Filler material may alternatively be charged directly from bags when the net weight of bag contents is known from the manufacturer. Using the scale, inert filler is then weighed to be poured according to the proportions of 33.3 weight percent +/−1% 12-hydroxy stearic acid, 33.3 weight percent +/−1% gypsum, and 313 weight percent +/−1% sodium chloride. The projectiles may also include an amount of clean inert scrap material of varying amounts.

According to the foregoing, 12-hydroxy stearic acid is added to the kettle and melted thoroughly. Preferably, 12-hydroxy stearic acid is added prior to blending in the remaining ingredients. A “heal” of 12-hydroxy stearic acid is prepared. The 12-hydroxy stearic acid heal is introduced into the kettle and melted sufficiently to provide a liquid base. While blending at approximately 20 rpm +/−10 rpm, anhydrite calcium sulfate and sodium chloride are then added, and preferably added slowly to prevent clumping. Specifically, gypsum and sodium chloride are added in any order in the respective proportional quantities and at a rate that allows uniform wetting without clumping.

Color may also be added at this time. Coloring may then be added to the mixture in an amount or level which produces the desired color, and is blended into the mixture. In a preferred embodiment, prior to loading the munition with the inert filler, the mixture is blended/mixed/agitated until it forms a smooth texture and has an even color.

Preferably, prior to the preparation of the inert filler, all explosives are removed from the location of the kettle and the inert material weighing areas during the charging or warming of the kettle and during mixing and loading operations. The kettle is turned on by activating a control operably connected thereto. As indicated, the kettle includes a water or steam jacket which surrounds the perimeter of the kettle. The control is used to control a heat exchange, and thereby adjust the temperature of the water or steam, and as a result, the kettle, to the designated or preferred degree. In a preferred embodiment, the kettle temperature is adjusted to a range of approximately from 200° F. to 220° F. As indicated, the kettle of a preferred embodiment also includes an agitator, the speed of which is controlled by the control. The agitator of a preferred embodiment comprises one or more rotating blades secured within the kettle. In a preferred embodiment, the agitator is adjusted to full speed, preferably a speed of between 10 and 30 rpm for blending operations.

Once the mixture is blended, loading occurs. Munitions, such as for instance, mortars or projectiles, are formed and received for loading with an empty cavity. The projectiles are then arranged for loading. For instance, they may be arranged on a cart with open end up, or more specifically, open nose end up, for receiving inert material. Where a nose cap is provided on the projectile, the nose cap may be removed. A plurality of projectiles are arranged on a cart for loading. The interior of the projectile, when necessary, is inspected and/or cleared of foreign material or removed if defective. The kettle in one embodiment may be tipped to unload or remove the material prepared therein.

Prior to loading into the projectile, the temperature of the mixture is measured. Preferably the temperature ranges from approximately 200° F. to 220° F. The projectiles are then loaded. Specifically, a funnel is inserted into the nose cavity of the projectile. No thread protector is required (unless projectile or mortar body is to be filled completely), although the inclusion of one would not depart from the overall scope of the present invention. The melted/wetted mixture of inert filler is then poured into the projectile to substantially fill the projectile. More specifically, the projectile, by pouring the mixture, is filled with inert filler through the funnel to a weight and or volume as required by customer to achieve a proper zone weight to most closely compare with the HE loaded projectile or mortar. Depending on customer application loading may occur in stages.

### EXAMPLES

The following Examples are set forth so as to provide those of ordinary skill in the art with a complete disclosure and description of the methods claimed herein, their performance, and evaluation, and are intended to be purely exemplary of the invention and are not intended to limit the scope of what is regarded as the invention. Efforts have been made to ensure accuracy with respect to numbers (e.g., amounts, temperature, etc.) but some errors and deviations should be taken into account.

### Example 1

The inert filler described herein was subject to density analysis. In particular, a number of density sections were taken from an inert filler having 33.3 weight percent glyceride, 33.3 weight percent dead burned gypsum, and 33.3 weight percent sodium chloride. The results of the analysis are presented in Table 1.

The Laboratory Procedure for measuring Density (In Vacuo) is described and is embodied in ASTM D792-66 Specific Gravity and Density of Plastics by displacement; MIL-STD-650, Method 202.1 Density (In Vacuo) which is incorporated herein by reference. Density is measured in grams/cubic centimeters.

To measure density, the following is required: a balance: accurate to within 0.0002 grams; milli-Q water—degassed by vacuum containing 0.01% aerosol; wire with loop on end to carry sample; crystallization dish or beaker of suitable size; thermometer; support; glass standard; and low form crystallization dish. First the glass standard and test material are conditioned at room temperature and temperature is recorded. The weight of the glass standard and the test specimens is then taken and recorded. The weighed standard or sample is placed in the crystallization dish with the 0.01% aerosol solution. After the sample has become thoroughly wet, any adhering bubbles are dislodged. A support is placed over the balance weigh pan. The wire loop is suspended from the pan hanger into the beaker. Water saturated with material under test containing 0.01% aerosol to the crystallization dish is added until the loop of the wire is completely immersed and it is deep enough to cover the sample when tested. The balance is then zeroed. The test specimen is placed in the loop and completely immersed in the solution. The weight of the immersed specimen is taken and recorded.

The apparent density of the glass standard is calculated as follows:

(STD_{AP})=Standard Apparent Density=A/(A−B)
Where:
   A=weight of the glass standard in air, gm
   B=weight of glass standard in water, gm

The density (in vacuo) of the glass standard is calculated as follows:

(STD_{in Vacuo})=Density (in vacuo)=(STD_{AP}) apparent density of test specimen multiplied by the density of water at test water temperature gm/cc.
It is noted that glass beads with known densities can also be used as (STD_{in Vacuo}).
The correction factor (F_{C} which is applied to the apparent densities of the sample) is calculated.

F_{C}=(STD_{AP})/(STD_{in Vacuo})

The density (in vacuo) of the specimen is calculated as follows:

(STDsₐₘₚᵢₑ)=Sample Apparent Density=A/(A−B)
Where:
   A=weight of the sample in air, gm
   B=weight of sample in water, gm

Density (in vacuo), gm/cc=(STD_{Sample}) apparent density of the specimen*(F_{C}) correction determined

TABLE 1
Density of Inert Filler

| Sample | Density (grams/cc) |
|---|---|
| 1 | 1.637 |
| 2 | 1.637 |
| 3 | 1.636 |
| 4 | 1.634 |
| 5 | 1.631 |
| 6 | 1.636 |
| 7 | 1.634 |
| 8 | 1.637 |
| 9 | 1.639 |

As can be seen from Table 1, the Density of the Inert Filler has an average value of 1.636 grams/cc.

### Example 2

The reactivity of various materials with the inert filler material was performed. Method 504.1, according to Military Standard 650, which is incorporated herein by reference, was used as follows.

The specimen is first prepared. The specimen consists of 5 g of the inner filler having the percentages described herein and 5 g of the contact material (the material placed in contact with the inert filler). A 2.5 g portion of each of the materials is tested as received except in the case of solvent containing contact materials (paints, adhesives, etc.) which would in normal usage be in the dry state. In this case the materials are air dried on glass plates and removed in the form of films for testing. The remaining portion of the inert filler and contact material are reduced to a practicable fineness for intimacy of contact. Explosives are pulverized under gentle pressure in an agate mortar; metals are tested as fine milled chips or fillings; films, cloth and paper are cut into ⅛ inch squares; propellants are rasped or milled to a fineness of approximately 12 mesh.

The apparatus used in this method is identical with that used in Method 503.1, according to Military Standard 650, which is incorporated herein by reference, and is a vacuum stability measuring apparatus.

The vacuum stability measuring apparatus is first standardized by determining the volume of the heating tube by filling it with mercury from a burette until the mercury reaches the level at which it will contact the ground glass joint of the capillary tube, and determining the unit capacity of the capillary by placing exactly 10 g of mercury in its cup, and manipulating the tube so that all the mercury passes into the long (85-cm) section of the capillary. Making sure that the mercury remains as a continuous column, the length of the mercury column at three positions in the long section of the capillary is measured, and the average of three measurements is taken. The unit capacity of the capillary is calculated, using the following formula:

B=W/13.59L
Where:
B=unit capacity of capillary, ml. per mm
W=weight of mercury, gm.
L=average length of mercury column, mm.

2.5 g of inert filler is placed in one heating tube and 2.5 g of contact material is placed in a second heating tube. In a third tube a mixture of 2.6 g of the inert filler and 2.5 g of contact material are placed. The volume of gas evolved is determined as specified in Method 503.1, which is incorporated herein by reference. Specifically, the dried specimen is placed in the heating tube. The ground glass joint of the capillary tube is coated with a light film of petroleum jelly, and an airtight connection is made between the heating tube and the capillary by pressing the tube up against the capillary with a twisting motion. The apparatus is mounted on a rack so that the long section of the capillary is nearly vertical, and the cup at the bottom rests on a solid support. The cup is filled with 7.0 ml of mercury and a vacuum line is connected to the mouth of the cup. The capillary is evacuated to a pressure of approximately 5 mm of mercury (absolute). When the pressure has been reduced to 5 mm of mercury, the vacuum line is removed and the mercury is allowed to enter the capillary. The following data is recorded:
a. Length of capillary from heating tube joint to surface of mercury pool in cup (C1).
b. Height of mercury column above the surface of the mercury pool (H1).
c. Barometric pressure in millimeters of mercury (P,).
d. Temperature of room in degrees centigrade (t,).

The heating tube is then immersed in the constant temperature bath and heated for 40 hours. The heated tube is removed from the constant temperature bath and allowed to cool to room temperature and the above data is re-measured and recorded. The following data is recorded:
The volume of gas (at standard temperature and pressure) liberated during test is then calculated, as follows:

Volume of gas, ml={A+CB}{(273−H)/(760−(273−0)}−{−A+C₁B}{(273P₁−H₁)/(760(273+t₁))}

### Where:

A=volume of heating tube (less 5 ml. allowance for specimen).
H1=height of mercury column above surface of mercury pool at BEGINNING of test, mm. (par. 4.7).
B=unit capacity of capillary ml. per mm. (par. 4.1).
C=length of capillary from heating tube joint to top of mercury column at END of test, mm.
(par. 4.10).
P=atmospheric pressure at END of test, mm. (par. 4.10).
P1=atmospheric pressure at BEGINNING of test, mm. (par. 4.7).
C1=length of capillary from heating tube joint to top of mercury column at BEGINNING of test, mm. (par. 4.7).
t=temperature of room at END of test, ° C. (par. 4.10),
t1=temperature of room at BEGINNING of test, ° C. (par. 4.7).
H=height of mercury column above surface of mercury pool at END of test, mm. (par. 4.10).

The amount of gas produced by the mixture of contact material and the explosive in excess of the amount of gas evolved by the materials themselves is then determined, as follows:

Gas due to reactivity, ml=A−(B+C).

### Example 3

The inert filler described herein was subject to an analysis of reactivity with aluminum using the above-described method of Example 2, aluminum being the “contact material.” In particular, an inert filler having at least 33.3 weight percent glyceride, 33.3 weight percent dead burned gypsum, and 33.3 weight percent sodium chloride was mixed with aluminum according to the method. The results of the analysis are presented in Table 2.

TABLE 2
Gas Evolution from Mixture of Inert Filler with Aluminum

| Gas Source | Volume (mL) |
|---|---|
| Inert Filler | 0.07 |
| Aluminum | 0.18 |
| Mixture | 0.06 |
| Reaction | 0.16 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

Under current standards for explosive devices, a reactivity level up to an including slight reactivity (3.0 mL) is considered acceptable compatibility. As can be seen, the inert filler provides results indicating that the mixture, the components, and the reaction are negligibly reactive. Accordingly, the inert filler is compatible with aluminum.

### Example 4

The inert filler described herein was subject to an analysis of reactivity with silicone grease using the above-described method of Example 2, silicon grease being the contact material. In particular, an inert filler having at least 33.3 weight percent glyceride, 33.3 weight percent dead burned gypsum, and 33.3 weight percent sodium chloride was mixed with silicone grease according to the above-described method. The results of the analysis are presented in Table 3.

TABLE 3
Gas Evolution from Mixture of Inert Filler with Silicone Grease

| Gas Source | Volume (mL) |
|---|---|
| Inert Filler | 0.07 |
| Silicone Grease | −0.07 |
| Mixture | 0.06 |
| Reaction | 0.06 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

Minus values of low order—(0.10-0.30) are accepted as essentially indicative of no reactivity. Minus values of higher order may indicate a stabilizing or blanketing effect produced by the contact materials upon the pyrotechnic and are be taken into account by the investigator in evaluation of the data. As can be seen, the inert filler provides results indicating that the mixture, the components, and the reaction are negligibly reactive. Accordingly, the inert filler is compatible with silicone grease.

### Example 5

The inert filler described herein was subject to an analysis of reactivity with black powder using the above-described method of Example 2. In particular, an inert filler having at least 33.3 weight percent glyceride, 33.3 weight percent dead burned gypsum, and 33.3 weight percent sodium chloride was mixed with black powder according to the above-described method, black powder being the contact material. The results of the analysis are presented in Table 4.

TABLE 4
Gas Evolution from Mixture of Inert Filler with Black Powder

| Gas Source | Volume (mL) |
|---|---|
| Inert Filler | −0.07 |
| Explosive (black powder) | 0.04 |
| Mixture | 0.10 |
| Reaction | 0.14 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

As can be seen, the inert filler provides results indicating that the mixture, the components, and the reaction are negligibly reactive. Accordingly, the inert filler is compatible with black powder.

### Example 6

The inert filler described herein was subject to an analysis of reactivity with TNT using the above-described method of Example 2, TNT being the contact material. In particular, an inert filler having at least 33.3 weight percent glyceride, 33.3 weight percent dead burned gypsum, and 33.3 weight percent sodium chloride was mixed with TNT according to the above-described method. The results of the analysis are presented in Table 5.

TABLE 5
Gas Evolution from Mixture of Inert Filler with TNT

| Gas Source | Volume (mL) |
|---|---|
| Inert Filler | −0.05 |
| Explosive (TNT) | 0.02 |
| Mixture | 0.01 |
| Reaction | 0.04 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

As can be seen, the inert filler provides results indicating that the mixture, the components, and the reaction are negligibly reactive. Accordingly, the inert filler is compatible with TNT.

### Example 7

The inert filler of a preferred embodiment described herein was subject to an analysis of reactivity using the above-described method of Example 2. In particular, an inert filler having at least 33.3 weight percent glyceride, 33.3 weight percent dead burned gypsum, 33.3 weight percent sodium chloride, and red food coloring was mixed and the reactivity measured according to the above-described method. The results of the analysis are presented in Table 6.

TABLE 6
Gas Evolution from Mixture of Inert Filler

| Gas Source | Volume (mL) |
|---|---|
| Glyceride | 0.14 |
| Food Coloring | 0.00 |
| Sodium Chloride | 0.11 |
| Gypsum | 0.01 |
| Mixture | 0.04 |
| Reaction | −0.22 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

As can be seen, the inert filler provides results indicating that the mixture, the components, and their reaction are negligibly reactive. Accordingly, the components of the inert filler are compatible in a mixture.

### Example 8

The inert filler described herein was subject to an analysis of reactivity with red oxide primer using the above-described method of Example 2, red oxide primer being the contact material. In particular, an inert filler having at least 33.3 weight percent glyceride, 33.3 weight percent dead burned gypsum, and 33.3 weight percent sodium chloride was mixed with red oxide primer according to the above-described method. The results of the analysis are presented in Table 7.

TABLE 7
Gas Evolution from Mixture of Inert Filler with Red Oxide Primer

| Gas Source | Volume (mL) |
|---|---|
| Inert Filler | 0.10 |
| Red Oxide Primer | 1.60 |
| Mixture | 1.49 |
| Reaction | −0.21 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

As can be seen, the inert filler provides results indicating that the mixture, the components, and the reaction are either negligibly reactive or very slightly reactive. Accordingly, the inert filler is compatible with red oxide primer.

### Example 9

The inert filler described herein was subject to an analysis of reactivity with green enamel top coat paint (olive drab) using the above-described method of Example 2, green enamel paint being the contact material. In particular, an inert filler having at least 33.3 weight percent glyceride, 33.3 weight percent dead burned gypsum, and 33.3 weight percent sodium chloride was mixed with the green enamel paint according to the above described method. The results of the analysis are presented in Table 8.

TABLE 8
Gas Evolution from Mixture of Inert Filler with
Green Enamel Top Coat Paint (olive drab)

| Gas Source | Volume (mL) |
|---|---|
| Inert Filler | 0.10 |
| Green Enamel | 1.71 |
| Mixture | 1.50 |
| Reaction | −0.31 |

whereby:

| Volume (mL) | Reactivity |
|---|---|
| <0.0 | not reactive |
| 0.0 to 1.0 | negligibly reactive |
| 1.0 to 2.0 | very slightly reactive |
| 2.0 to 3.0 | slightly reactive |
| 3.0 to 5.0 | moderately reactive |
| >5.0 | excessively reactive |

As can be seen, the inert filler provides results indicating that the mixture, the components, and the reaction are negligibly reactive or very slightly reactive. Accordingly, the inert filler is compatible with green enamel top coat paint (olive drab).

### Example 10

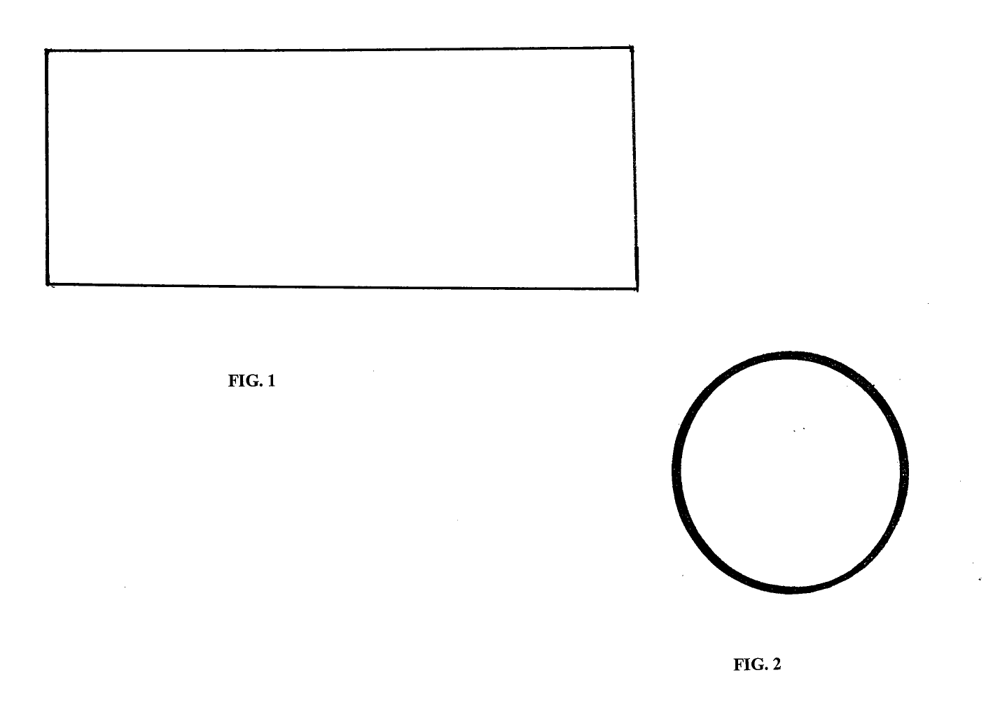

Thermal expansion tests were also performed on the inert filler described herein. Three samples of a cast comparable to a munition, each 5 inches in length were machined at a tool and die to have parallel ends. One specific measuring location was selected and marked for each sample. An example of a sample cast is shown in FIGS. 1 & 2. The samples were each loaded with an inert filler as described herein, to a density of approximately 1.63 g/cc. Using commonly commercially available gauge blocks and a dial indicator, the samples were measured at room temperature and then after a minimum of four hours at a number of target temperatures. Specifically, the samples were each maintained and measured at different temperatures, including +20° C., +40° C., −20° C., and −40° C. The results of the analysis are presented in Table 9.

TABLE 9
Thermal Expansion of Sample Cast

| | Coefficient of Thermal | Coefficient of Thermal | Coefficient of Thermal | Coefficient of Thermal |
|---|---|---|---|---|
| | Expansion (CTE) @ +20° C. | Expansion (CTE) @ +40° C. | Expansion (CTE) @ −20° C. | Expansion (CTE) @ −40° C. |
| Sample | (μin/in/deg. C.) | (μin/in/deg. C.) | (μin/in/deg. C.) | (μin/in/deg. C.) |
| 1 | 65 | 65 | 65 | 65 |
| 2 | 65 | 65 | 65 | 65 |
| 3 | 65 | 65 | 65 | 65 |

The rate of expansion was constant throughout the entire range, and constant from sample to sample to within the limit of accuracy of the equipment used. Accordingly, over the range of −40° C. to +40° C., the mean coefficient of thermal expansion for the inert filler is 65 μin/in/deg. C. The coefficient of thermal expansion continues to remain the same in the temperature range of +20° C. to +60° C. The coefficient of thermal expansion corresponds with that of TNT.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail, steps, or structure may be made without departing from the spirit of the invention as defined in the appended claims.

Although the present invention has been described with reference to preferred embodiments, persons skilled in the art will recognize that changes may be made in form and detail without departing from the spirit and scope of the invention.

We claim:

1. An inert filler for a munition comprising a mixture of a calcium sulfate and a fatty acid.

2. The inert filler of claim 1, further comprising a density of at least approximately 1.63 grams/cc.

3. The inert filler of claim 1, wherein the calcium sulfate may be included in a gypsum mixture.

4. The inert filler of claim 3, wherein the gypsum mixture is dead burned gypsum.

5. The inert filler of claim 1, wherein the fatty acid comprises 12-hydroxy-stearic acid.

6. The inert filler of claim 1, wherein the mixture further comprises an inorganic sodium compound.

7. The inert filler of claim 6, wherein the inorganic sodium compound is sodium chloride.

8. The inert filler of claim 1, further comprising a coloring compound.

9. The inert filler of claim 8, wherein the coloring compound includes a glycol.

10. The inert filler of claim 1, wherein the mixture comprises from approximately 23 to 43 weight percent calcium sulfate, approximately 23 to 43 weight percent fatty acid and approximately 23 to 43 weight percent inorganic sodium compound.

11. The inert filler of claim 10 wherein the mixture comprises at least approximately 33.3 weight percent calcium sulfate, 33.3 weight percent fatty acid, and 33.3 weight percent inorganic sodium compound.

12. An inert filler for a munition comprising a mixture of a calcium sulfate, a gypsum, and a fatty acid.

13. The inert filler of claim 12, further comprising a coloring compound.

14. The inert filler of claim 12, wherein the coloring compound includes a glycol.

15. A munition device including an inert filler comprising a mixture of a calcium sulfate, a fatty acid, and an inorganic sodium compound.

16. A method for preparing an inert material for use in a munition, comprising the steps of obtaining a calcium sulfate, a fatty acid, and an inorganic sodium compound, heating the fatty acid to form a liquid base and subsequently, adding proportional quantities of calcium sulfate and inorganic sodium to uniformly form a wet mixture of inert filler for placing into a munition.
